(19) United States
(12) Patent Application Publication
(10) Pub. No.: US 2008/0234925 A1
(43) Pub. Date: Sep. 25, 2008

(54) NAVIGATION-AIDS METHOD AND ELECTRONIC NAVIGATION DEVICE USING THE SAME

(75) Inventor: Chung-Hao Lo, Taipei (TW)

Correspondence Address: KIRTON AND MCCONKIE, 60 EAST SOUTH TEMPLE,, SUITE 1800, SALT LAKE CITY, UT, 84111, US

(73) Assignee: MITAC INTERNATIONAL CORP., Taipei (TW)

(21) Appl. No.: 12/051,324

(22) Filed: Mar. 19, 2008

(30) Foreign Application Priority Data
Mar. 21, 2007 (TW) 096109808

(51) Int. Cl. G01C 21/00; G01S 5/00; G06F 3/01

(52) U.S. Cl. 701/201; 701/213; 701/200

(57) ABSTRACT

A navigation-aids method is useful for guiding a group of associated vehicles including a first vehicle and a second vehicle. The first vehicle is equipped with a first electronic navigation device and the second vehicle is equipped with a second electronic navigation device. An informing message is generated by the first electronic navigation device in response to the occurrence of a traffic event. The informing message containing position and traffic-event information is transmitted from the first electronic navigation device to the second electronic navigation device. A navigation-aids operation is executed by the second electronic navigation device depending on the informing message, thereby properly guiding the second vehicle.

### FIELD OF THE INVENTION

The present invention relates to a navigation-aids method, and more particularly to a navigation-aids method for performing interactive guidance between/among vehicles equipped with electronic navigation devices. The present invention also relates to an electronic navigation device capable of executing an interactive guidance function with another electronic navigation device.

### BACKGROUND OF THE INVENTION

Global Positioning System (GPS) that was only used for guiding crafts or facilitating geographic survey is now applied to various fields in human's lives. For example, GPS replaces radio communication as a flight-guiding standard, co-works with electronic map to help a driver plan his driving route, helps on locating certain people or objects, or provides information of certain landmarks for the reference of people doing an outdoor activity like hiking, skiing, mountain-climbing, racing, etc., to locate himself and find his way. Generally speaking, One of the most popular and mature applications of GPS is for navigation aids of vehicles.

Please refer to FIG. 1, in which the operational principle of GPS is briefly illustrated. The system 1 includes an electronic navigation device 10 receiving satellite signals 110 from satellites 11 orbiting around the earth. Then a triangulation method is implemented to do calculation based on the received satellite signals 110 so as to realize position information in a two-dimensional or three-dimensional coordinate. When the GPS 1 is equipped in a vehicle and proper data are inputted into the electronic navigation device 10, suitable driving routes may further be programmed in addition to positioning of the vehicle.

An example of the electronic navigation device 10 conventionally used in the art will be illustrated hereinafter with reference to FIG. 2. The electronic navigation device 10 includes a processor 20, a satellite signal receiver 21, an input unit 22, a memory 23, a display 24 and a wireless transmission unit 25, wherein the processor 20 communicates and works with the satellite signal receiver 21, input unit 22, memory 23, display 24 and wireless transmission unit 25. After the satellite signal receiver 21 receives data information from satellites (not shown), the processor 20 calculates the data to realize a position in a coordinate. Meanwhile, the processor 20 reads an electronic map stored in the memory 23 and has the map shown on the display 24. Via the input unit 22, a user may input additional data to the electronic navigation device 10 to be processed by the processor 20. Moreover, the wireless transmission unit 25 can be used to exchange information with other electronic navigation devices (not shown), e.g. exchange position information of associated vehicles.

As mentioned above, it is feasible to show positions of associated vehicles on the display 24. It is a pity, however, that the realized information has not been taken advantage of to expand the utility of the system except showing relative positions.

### SUMMARY OF THE INVENTION

Therefore, the present invention provides a navigation-aids method for providing more information and performing advanced functions based on the information of associated vehicles transmitted to an electronic navigation device.

The present invention relates to a navigation-aids method for guiding a group of associated vehicles including a first vehicle and a second vehicle, wherein the first vehicle is equipped with a first electronic navigation device and the second vehicle is equipped with a second electronic navigation device. The method includes steps of: generating an informing message by the first electronic navigation device in response to the occurrence of a traffic event, and transmitting the informing message containing position and traffic-event information from the first electronic navigation device to the second electronic navigation device; and executing a navigation-aids operation by the second electronic navigation device depending on the informing message.

In an embodiment, the navigation-aids method further includes a step of generating an indicating message by the second electronic navigation device in response to the informing message. Accordingly, the navigation-aids operation includes outputting the indicating message, e.g. a voice message, a literal message and/or a light message, as a warning message.

In an embodiment, the navigation-aids operation includes programming a new route.

In an embodiment, the traffic-event information included in the informing message is manually inputted into the first electronic navigation device or automatically generated when the traffic event occurs. For example, the traffic-event information can be automatically generated when the first electronic navigation device detects a velocity change of the first vehicle larger than a threshold which can be preset in the system or by a user.

In an embodiment, the position information included in the informing message is transmitted to a global positioning system.

The present invention also relates to an interactive guiding system for use with a group of associated vehicles including a first vehicle and a second vehicle. The interactive guiding system includes a first electronic navigation device disposed in the first vehicle for cooperating with a global positioning system to position and guide the first vehicle, generating an informing message in response to the occurrence of a traffic event, and transmitting the informing message to the second electronic navigation device; and a second electronic navigation device disposed in the second vehicle for cooperating with the global positioning system to position and guide the second vehicle, the second electronic navigation device, and executing a navigation-aids operation depending on the informing message.

The present invention further relates to an electronic navigation device, which includes a traffic message generator for processing position information and traffic-event information into an informing message to be outputted in response to the occurrence of a traffic event, and executing a navigation-aids operation in response to an external informing message; and a wireless transceiver coupled to the traffic message generator for wirelessly transmitting the informing message out or wireless receiving the external informing message.

In an embodiment, the electronic navigation device further includes an output unit for outputting an indicating message generated by the navigation-aids operation. For example, the output unit may include a speaker, a display and/or an LED indicator to output the indicating message as a voice message, a literal message and/or a light message.

In an embodiment, the electronic navigation device further includes an input unit for manually inputting the traffic-event information into the traffic message generator to be processed. For example, the input unit may include a touch panel, a microphone and/or an array of selective buttons to receive the traffic-event information from a user. In another embodiment, the traffic message generator further detects a velocity change of a vehicle that the electronic navigation device is disposed in, and generates the informing message when the velocity change exceeds a threshold which can be preset in the system or by a user.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram illustrating a global positioning system (GPS);

FIG. 2 is a functional block diagram illustrating an electronic navigation device for use in GPS;

FIG. 3 is a functional block diagram illustrating an embodiment of an electronic navigation device according to the present invention;

FIGS. 4A and 4B are functional block diagrams illustrating an interactive guiding system for guiding associated vehicles that are respectively equipped with electronic navigation devices of the present invention;

FIG. 5 is a flowchart of a navigation-aids method according to an embodiment of the present invention; and

FIGS. 6A and 6B are schematic diagrams exemplifying the pictures shown on electronic navigation devices when traffic events happen.

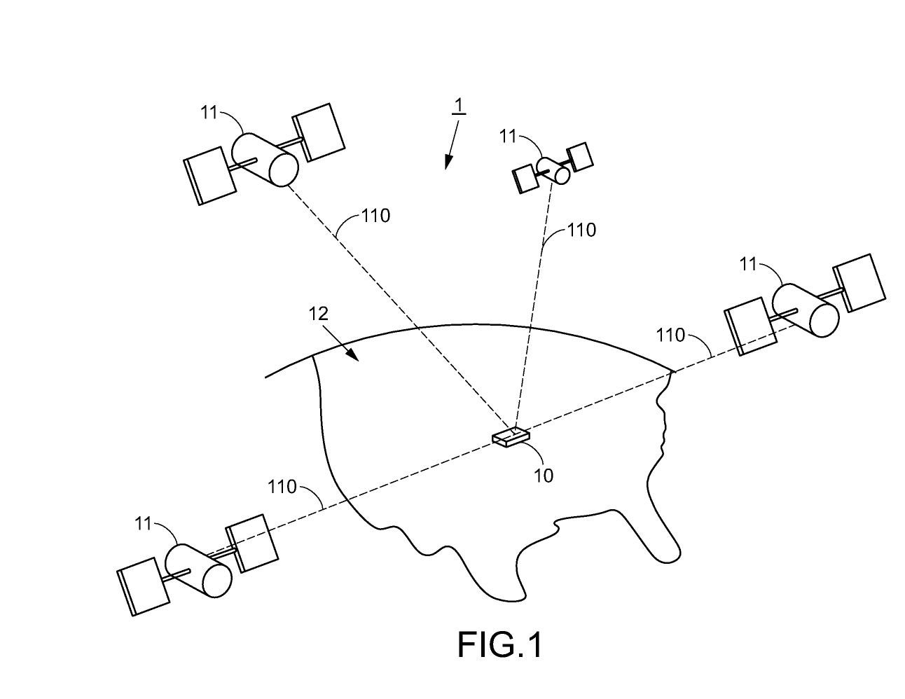

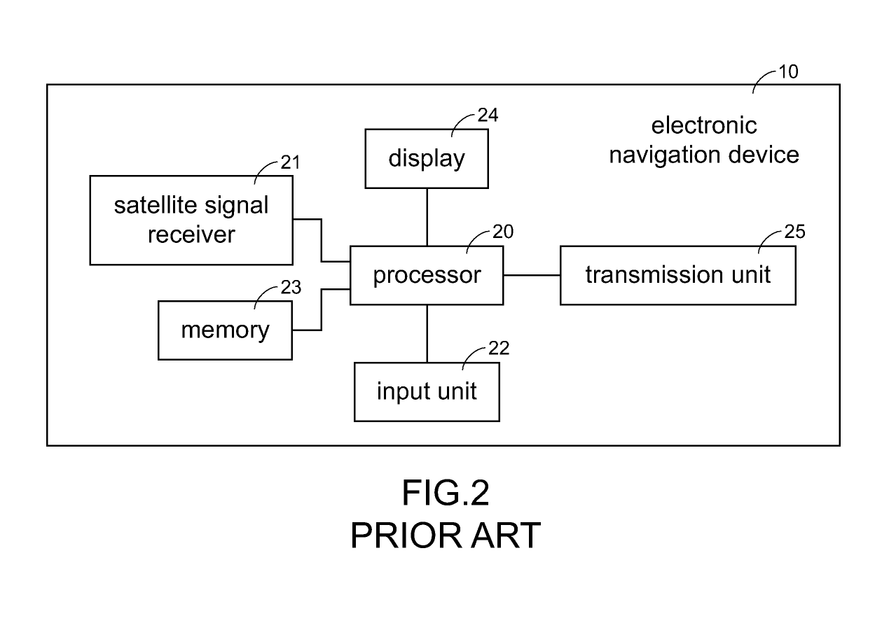

### DETAILED DESCRIPTION OF PREFERRED EMBODIMENTS

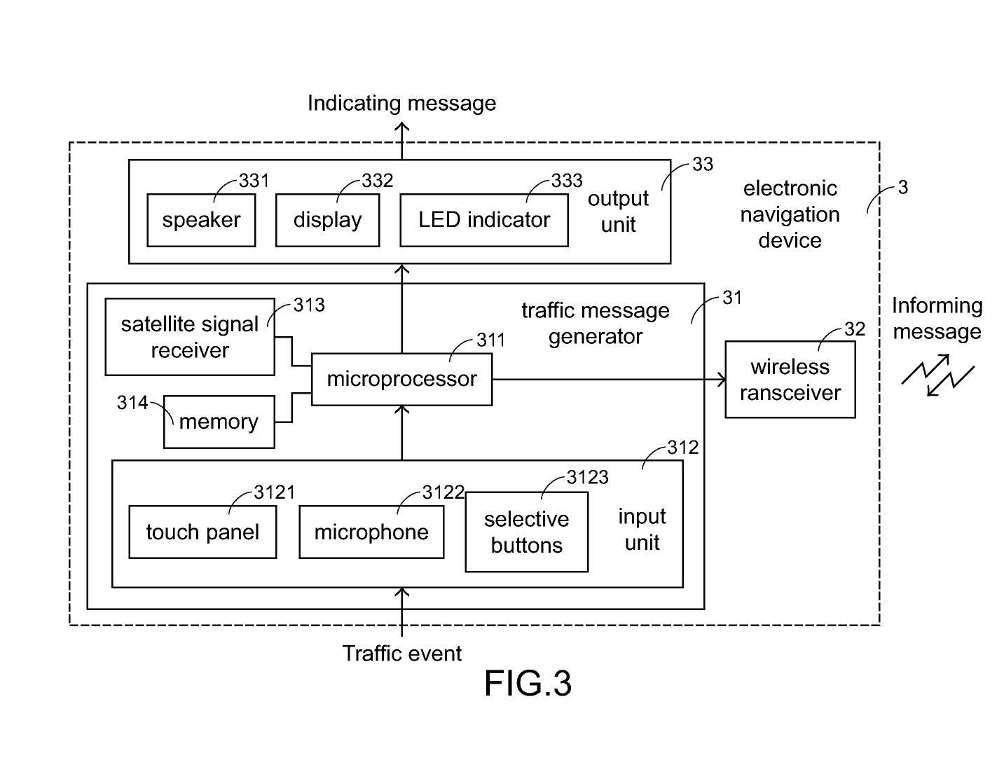

Please refer to FIG. 3. An electronic navigation device with enhanced functions according to an embodiment of the present invention is illustrated. The electronic navigation device 3 includes a traffic message generator 31, a wireless transceiver 32 and an output unit 33. In the traffic message generator 31, a microprocessor 311, an input unit 312, a satellite signal receiver 313 and a memory 314. When the electronic navigation device 3 is disposed in a first vehicle and made associated with one or more other vehicles, functions more than locating the associated vehicles can be achieved. After the satellite signal receiver 313 of the electronic navigation device 3 receives data information from satellites (not shown), the microprocessor 311 calculates the data to realize a position of the first vehicle in a coordinate. The microprocessor 311 is further capable of generating an informing message and storing the message into the memory 314 when the first vehicle encounters a certain traffic condition and a traffic message is inputted into the electronic navigation device 3 via the input unit 312. The informing message preferably contains information of the position of the first vehicle and the description of the traffic condition. The input unit 312 is used for the driver to update the traffic condition he is encountering for other drivers' reference, and for example, can be a touch panel 3121, a microphone 3122 and/or an array of selective buttons 3123. The selective items of the traffic conditions can be preset and stored in the memory 314 of the electronic navigation device.

Likewise, the electronic navigation devices disposed in other vehicles may generate their own messages according to the traffic conditions they encountered. By outputting and/or receiving the messages via respective wireless transceivers 32, the associated vehicles may exchange traffic condition information with one another. Furthermore, the traffic message generator 31 may generate an indicating message, which for example can be a voice message, a literal message and/or a light message, to be outputted by the output unit 33, thereby informing the driver of the situation and/or suggesting a new route. The output unit 33, for example, may include a speaker 331, a display 332 and/or a light-emitting diode (LED) indicator 333. In an embodiment, the display 332 of the output unit 33 can be integrated with the touch panel 3121 of the input unit 312.

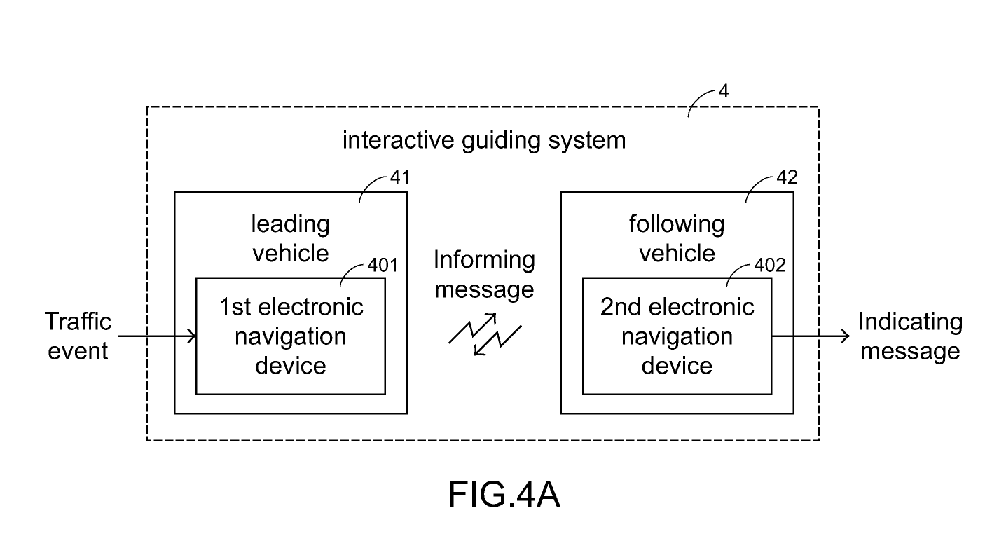

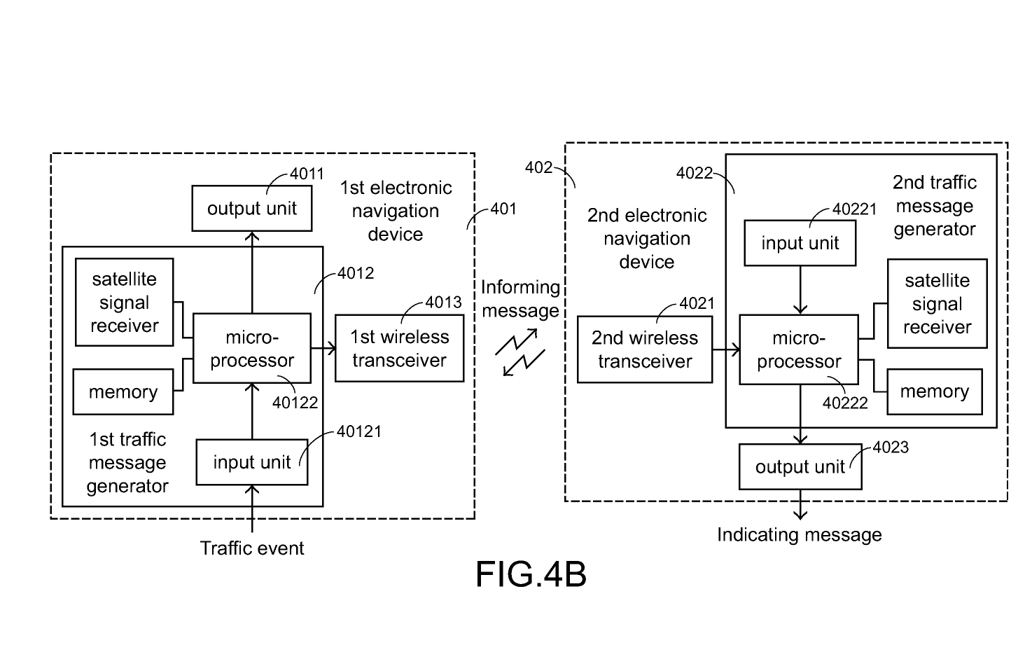

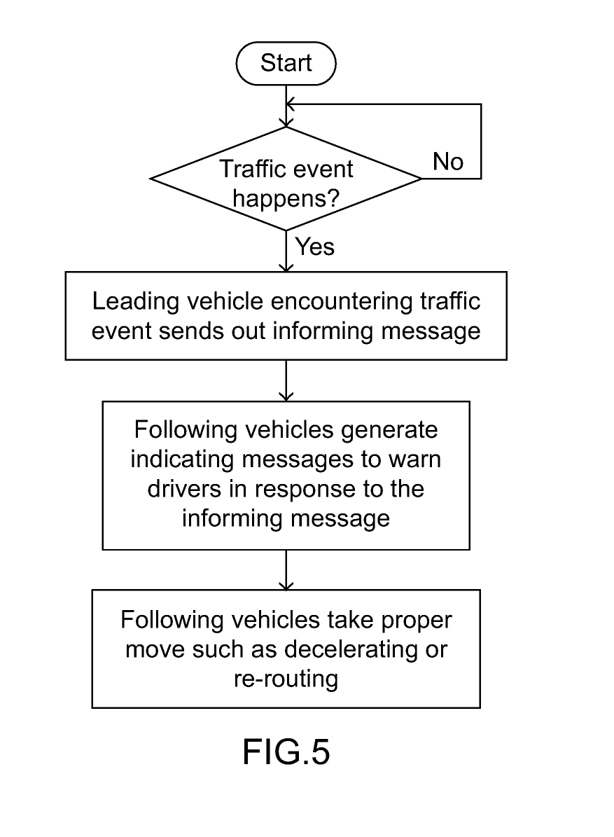

It is understood that interactive guiding means according to the present invention can be applied to two or more vehicles associated with one another. For illustrating purpose, however, interactive guiding means for use between two vehicles equipped with the electronic navigation devices of FIG. 3 are illustrated herein with reference to FIG. 4A and FIG. 4B. The navigation system 4 includes a first vehicle 41 equipped with a first electronic navigation device 401 and a second vehicle 42 equipped with a second electronic navigation device 402. Assume that the first vehicle 41 is preset to be a leading vehicle while the second vehicle 42 is a following vehicle. During the traveling of the vehicles, once the first vehicle is encountering a certain traffic condition, the driver in the first vehicle may input the information of the traffic condition into the electronic navigation device 401 via an input unit 40121 to be processed by a microprocessor 40122. Then an informing message is generated by a traffic message generator 4012 and transmitted out via a wireless transceiver 4013 of the electronic navigation device 401. In response to the message received from a wireless transceiver 4021 of the electronic navigation device 402, a microprocessor 40222 of the electronic navigation device 402 enables the output unit 4023 to generate an indicating message to inform the driver in the second vehicle 42 of the traffic condition the first vehicle 41 is encountering. Depending on the updated traffic condition, the driver in the following vehicle 42 may decide whether to follow the same route as the first vehicle 41 or not. The navigation-aids method as mentioned above is applicable to various situations on the road and is exemplified in the flowchart of FIG. 5.

In the above embodiment, the informing message is generated by the traffic message generator of the leading vehicle with the input of the traffic condition by the driver. In another embodiment, the informing message can also be automatically generated once the detecting means in the microprocessor of the leading vehicle detects a certain state change of the vehicle. For example, when the velocity of the vehicle 41 decreases to a level greater than a threshold which can be preset in the system or by a user, e.g. 50 km/hr (from 90 km/hr to 40 km/hr), due to a certain traffic condition the informing message will be automatically generated without the input of the driver. In a further embodiment, no leading or following vehicle is preset. Any of the vehicles may manually or automatically output an informing message to other vehicles.

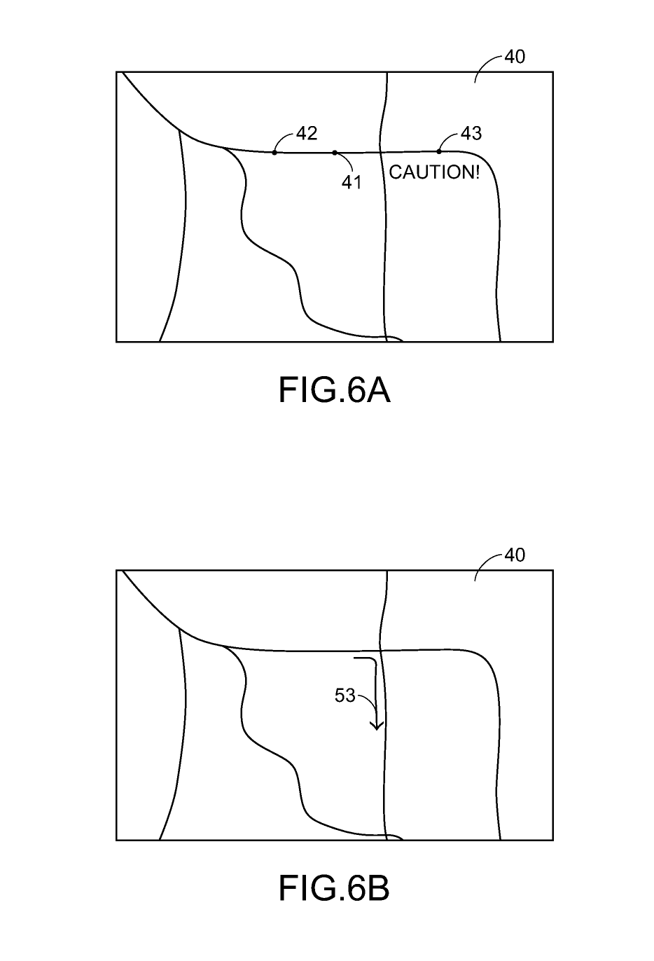

FIG. 6A and 6B schematically illustrate two exemplified cases that might happen on the road and how the present navigation-aids means works. In the case of FIG. 6A, the leading vehicle 41 encounters an obstacle on his way, so the driver inputs a warning voice or triggers a cautionary item via the input unit 4011. The traffic message generator 4012 then generates an informing message containing the inputted information and the position of the vehicle 41 in an electronic map. The informing message is transmitted out from the wireless transceiver 4013 and received by the second electronic navigation device 42 from the wireless transceiver 4021. The microprocessor 40222 processes the received informing message and has the output unit 4023 sound, emit light and/or show a warning sign. Therefore, on the display of the electronic navigation device 402, a warning sign “CAUTION!” marked near the position of the obstacle 42 as well as the positions of the vehicles 41 and 42 are shown on the electronic map 40, as shown in FIG. 6A.

On the other hand, in the case of FIG. 6B, the leading vehicle 41 encounters a traffic jam, so the drivers inputs a warning voice or triggers a re-routing item via the input unit 4011 to send out an informing message. In response to the informing message, the electronic navigation device 402 in the following vehicle 42 is automatically or manually triggered to plan a new route to escape from the traffic jam zone. Accordingly, the new route 53 as well as the positions of the vehicles 41 and 42 and the traffic jam zone 52 are shown on the electronic map 40, as shown in FIG. 6B.

It is understood from the above descriptions that by way of the interactive guiding means of the present invention, associated vehicles are not only able to locate positions of one another but also able to deal with a contingency or emergency. Thus the functions of the navigation system can be enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A navigation-aids method for guiding a group of associated vehicles including a first vehicle and a second vehicle, the first vehicle being equipped with a first electronic navigation device, the second vehicle being equipped with a second electronic navigation device, and the method comprising steps of:
generating an informing message by the first electronic navigation device in response to the occurrence of a traffic event, and transmitting the informing message containing position and traffic-event information from the first electronic navigation device to the second electronic navigation device; and
executing a navigation-aids operation by the second electronic navigation device depending on the informing message.

2. The navigation-aids method according to claim 1 further comprising a step of generating an indicating message by the second electronic navigation device in response to the informing message.

3. The navigation-aids method according to claim 2 wherein the navigation-aids operation includes outputting the indicating message as a warning message.

4. The navigation-aids method according to claim 3 wherein the indicating message is a voice message, a literal message, a light message or a combination thereof.

5. The navigation-aids method according to claim 1 wherein the navigation-aids operation includes programming a new route.

6. The navigation-aids method according to claim 1 wherein the traffic-event information included in the informing message is manually inputted into the first electronic navigation device when the traffic event occurs.

7. The navigation-aids method according to claim 1 wherein the traffic-event information included in the informing message is automatically generated by the first electronic navigation device when the traffic event occurs.

8. The navigation-aids method according to claim 7 wherein the traffic-event information is automatically generated when the first electronic navigation device detects a velocity change of the first vehicle larger than a preset threshold.

9. The navigation-aids method according to claim 1 wherein the position information included in the informing message is transmitted to a global positioning system.

10. An interactive guiding system for use with a group of associated vehicles including a first vehicle and a second vehicle, comprising:
a first electronic navigation device disposed in the first vehicle for cooperating with a global positioning system to position and guide the first vehicle, generating an informing message in response to the occurrence of a traffic event, and transmitting the informing message to the second electronic navigation device; and
a second electronic navigation device disposed in the second vehicle for cooperating with the global positioning system to position and guide the second vehicle, the second electronic navigation device, and executing a navigation-aids operation depending on the informing message.

11. The interactive guiding system according to claim 10 wherein the navigation-aids operation includes outputting a warning message or programming a new route.

12. The interactive guiding system according to claim 10 wherein the informing message contains traffic-event information manually inputted into the first electronic navigation device when the traffic event occurs.

13. The interactive guiding system according to claim 10 wherein the informing message contains traffic-event information automatically generated by the first electronic navigation device when the traffic event occurs.

14. An electronic navigation device, comprising:
a traffic message generator for processing position information and traffic-event information into an informing message to be outputted in response to the occurrence of a traffic event, and executing a navigation-aids operation in response to an external informing message; and
a wireless transceiver coupled to the traffic message generator for wirelessly transmitting the informing message out or wireless receiving the external informing message.

15. The electronic navigation device according to claim 14 further comprising an output unit for outputting an indicating message generated by the navigation-aids operation.

16. The electronic navigation device according to claim 15 wherein the output unit includes a speaker, a display, an LED indicator or a combination thereof to output the indicating message as a voice message, a literal message, a light message or a combination thereof.

17. The electronic navigation device according to claim 14 wherein the navigation-aids operation includes programming a new route.

18. The electronic navigation device according to claim 14 further comprising an input unit for manually inputting the traffic-event information into the traffic message generator to be processed.

19. The electronic navigation device according to claim 18 wherein the input unit includes a touch panel, a microphone, an array of selective buttons or a combination thereof to receive the traffic-event information from a user.

20. The electronic navigation device according to claim 14 wherein the traffic message generator further detects a velocity change of a vehicle that the electronic navigation device is disposed in, and generates the informing message when the velocity change exceeds a preset threshold.
